(19) United States
(12) Patent Application Publication
(10) Pub. No.: US 2010/0243639 A1
(43) Pub. Date: Sep. 30, 2010

(54) FLEXIBLE HORIZONTAL ELECTRODE PIPE

(76) Inventors: Gregory L. Beyke, Franklin, TN (US); Chad Crownover, Seattle, WA (US)

Correspondence Address: SCHNADER HARRISON SEGAL & LEWIS, LLP, 1600 MARKET STREET, SUITE 3600, PHILADELPHIA, PA, 19103, US

(21) Appl. No.: 12/729,613

(22) Filed: Mar. 23, 2010

Related U.S. Application Data
(60) Provisional application No. 61/162,863, filed on Mar. 24, 2009.

(51) Int. Cl. H05B 3/10

(52) U.S. Cl. 219/552; 29/611

(57) ABSTRACT

A flexible electrode and methods for using the same. The electrode includes one or more flexible conductive portions, and one or more substantially rigid conductive portions. The flexible electrode portion can be a slotted pipe, a flat plate or a rod. Methods for use of the flexible electrodes include in electric resistance heating, including for oil recovery and subsurface soil and water remediation applications.

This application is based on, and claims priority to, U.S. provisional application Ser. No. 61/162,863, filed Mar. 24, 2009, entitled Flexible Horizontal Electrode Pipe.

### BACKGROUND OF THE INVENTION

Electrical Resistance Heating (ERH) is a method of subsurface heating for such purposes as volatile contaminant removal or to enhance the recovery of a liquid such as crude oil. ERH uses electrodes to direct electrical current into the subsurface, the electrical current flows between the electrodes through existing (usually native) subsurface material to complete the current path. The inter-electrode current generates heat in the subsurface material through electrical resistance. To date, most or all electrodes have been installed vertically or at less than a 45° angle from vertical. One impediment to using horizontal electrodes is the lack of flexibility of the pipe that is traditionally used for ERH.

Accordingly, there is a need for a flexible electrode for use horizontally or at other non-perpendicular angles to the ground surface.

### SUMMARY OF THE INVENTION

A flexible electrode is disclosed and methods for using the same. The electrode includes one or more flexible conductive portions, and one or more substantially rigid conductive portions. As used herein the “rigid” portions are substantially rigid. It will be understood by those skilled in the art that that objects such as metal pipe may be considered rigid, but will have some flexibility such as when present in long lengths. Rigid pipes are those that are not readily bendable such as the inventive flexible electrode portions that will be described herein. The flexible electrode portion can be a slotted pipe, a flat plate or a rod.

In one aspect of the invention the flexible electrode is configured for use in electric resistance heating (ERH) applications. Methods are disclosed for use of the flexible electrodes for ERH with applications such as oil recovery and subsurface soil and water remediation.

### DESCRIPTION OF THE FIGURES

FIG. 1 depicts offset for horizontal electrodes according to an illustrative embodiment of the invention.

FIG. 2 depicts a flexible electrode according to an illustrative embodiment of the invention.

FIG. 3 depicts a flexible electrode having spiral slots according to illustrative embodiment of the invention.

### DETAILED DESCRIPTION OF THE INVENTION

In some cases, one desires to treat a region that is not readily-accessible to drilling by using vertical or near-vertical electrodes. The most common such example would be a heating location that is under a building. If the building activities will not allow a drill rig access, then the use of horizontal electrodes may be required. The phrase “horizontal electrode” as used herein is not limited to electrodes that are parallel or substantially parallel to the horizon, but instead differentiates the positioning of the electrodes from vertical or near vertical electrodes. A “horizontal electrode” as used herein means any electrode that cannot be installed by entry into the subsurface from a point directly or near directly above the subsurface volume to be heated. The horizontal electrode can be employed to circumvent an obstacle from any direction.

Horizontal drilling is commonly used to install a pipe and requires an offset distance at each end of the desired horizontal section. Drilling begins at an angle below horizontal and the boring is gradually curved to the horizontal. When the horizontal section of the boring is completed, the boring is curved upward to the surface. When the drill bit penetrates the surface, the desired pipe is connected to the drill bit and the pipe is pulled into the boring by retracting the drill bit. In other words, a drilling offset is generally required at both ends of the horizontal section. As the pipe typically used for ERH is fairly rigid, offsets can be significant, requiring use of additional lengths of pipe. In addition to being more costly, some locations may not be conducive to use of large offsets, such as when other buildings or obstacles are near by. Accordingly, it is desirable to have an electrode that reduces the offset necessary for use under obstacles such as building.

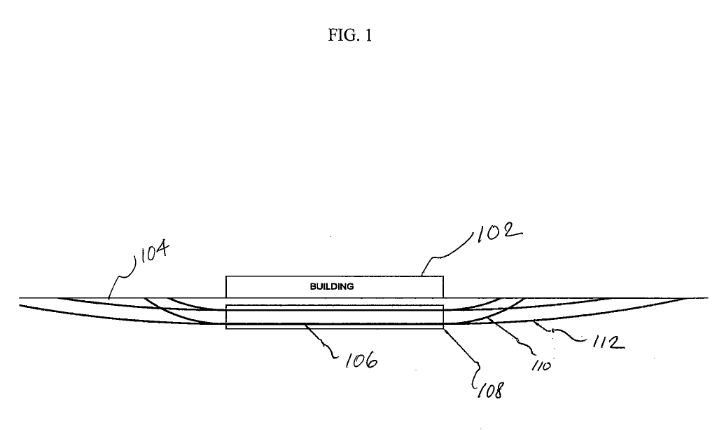

Illustrative offsets are shown in FIG. 1. The length of the required offset is determined by the depth of the horizontal section and the offset radius-of-curvature. The radius-of-curvature is usually dominated by the flexibility of the pipe to be installed. For this reason, horizontal drilling is often used to install high density polyethylene (HDPE) or other plastic pipe that is relatively flexible and can be installed with a small radius-of-curvature. However, plastic pipe doesn't conduct electricity and is not a suitable ERH electrode material. If it is desired to insert an electrode beneath building 102 below surface level 104, the electrode will necessarily need to curve from its entry point to below the building and then again from that below the building back to the surface. The electrode conductive interval is shown by reference number 106 and the desired treatment zone is shown by box 108. The offset required by a standard pipe is shown by curve 112. Curve 110 indicates a preferred offset, as can be obtained by using flexible electrodes according to illustrative embodiments of the invention.

Metal pipes are stiff, especially in the size range that provides sufficient surface area to transfer ERH current to the native subsurface materials (typically 3″ to 12″ diameter). A general rule-of-thumb for metal pipes is that the offset radius-of-curvature should be 100 feet for each inch of pipe diameter, e.g. a 600-ft radius would be required for a 6″ metal pipe.

The flexible electrodes can be up to 100 times more flexible than a conventional pipe. In theory, a 6″ pipe could be bent into a 6-ft radius. However, conventional drilling rigs are not capable of making such a tight bend in the subsurface. Most drill rigs are limited to a bend radius of 150 ft to 200 ft and there is not much reason to make a pipe that can easily bend more sharply than a 150-ft radius. For this reason, the pipe can have short flexible intervals that are interspersed with conventional intervals. One example would be a 6″ pipe with one 6 ft long spiral slot section in each 21-ft long “stick” of pipe. Such a pipe would easily bend into a 150-ft radius.

Embodiments of the invention consist of modifications to metal pipe, or substitutes for all or portions of metal pipe, in order to provide a flexible electrode with sufficient axial tensile strength, surface area, and axial electrical conductivity. Although flexibility in the vertical plane is most desired, flexibility in the horizontal plane can also be useful in order to avoid obstacles. In a broad sense, embodiments of the invention include mechanisms to reduce the bending moment of inertia of an electrode as compared to traditional metal pipe electrodes.

In most applications, low carbon steel is the preferred material for the metal pipes due to low cost and strength. If the subsurface environment was particularly corrosive and/or electrically conductive then copper or aluminum might be preferred over steel due to their greater corrosion resistance and greater current carrying capacity.

The optimum pipe diameter depends on the geometry of the site and the capacity of the local drilling rigs. For example, a 100-ft by 100-ft treatment region is relatively small and would economically favor metal pipes in the range of 3″ to 6″ diameter. A 400-ft by 400-ft region is relatively large and would favor metal pipes in the range of 6″ to 12″ diameter.

Three pipe modifications will be discussed as illustrative embodiments of the invention. The modifications include periodic substitutions of either: small diameter rod, flat plate, or specially slotted sections of pipe. The embodiments can be implemented alone or in conjunction with any of the other embodiments.

### Rod Flexible Segment

For the purposes of discussion, the “nominal pipe” will be assumed to be 6-inch schedule 40 low carbon steel. In most cases, the flexibility of a pipe or other object is inversely proportional to its moment-of-inertia in the bending plane. A 6-inch pipe has a cross-sectional area of 5.58 in² and a bending moment-of-inertia of 28 in. A circular rod with a diameter of 2.66 in would have the same cross-section area as a 6-inch pipe and therefore would have the same nominal axial strength and ability to carry electrical current. However, the rod moment-of-inertia is just 2.5 in⁴—in other words, the rod is over ten times more flexible than the pipe. However, the rod provides far less surface area than the pipe and therefore the rod segments must be limited to a small fraction of the total length. The rod segments suffer other disadvantages:
Welded transitions to the pipe are required at both ends of each flexible segment. These transitions must be custom-fabricated.
No fluid (such as crude oil or contaminant) can be transported the length of the pipe.
The variations in diameter can increase the pulling resistance required to emplace the pipe string.

If rods are used, preferably the rod section is 5 to 10 pipe diameters long. A rod will have 5% to 15% of the bending moment of inertia of the corresponding pipe.

### Plate Flexible Segment

Instead of a circular rod, the flexible segment could consist of a horizontal plate that is for example, the width of the pipe (6.625 in) and with a thickness of 0.84 in. This flat plate would have the same nominal axial strength and ability to carry electrical current. However, the plate bending moment-of-inertia is just 0.33 in⁴—in other words, the plate is about 100 times more flexible than the pipe in the vertical direction. The plate segment shares the disadvantages of the rod segment but would generally have greater surface area than the rod. It is noted that although we refer to a “flat” plate, the plate is flexible so can be bent and thus will not necessarily always have a flat configuration.

In an illustrative embodiment of the invention, every 10 ft. of the electrode is an approximately 2-3 ft plate. The flat plate can also be used throughout the length of the electrode instead of in one or more segments.

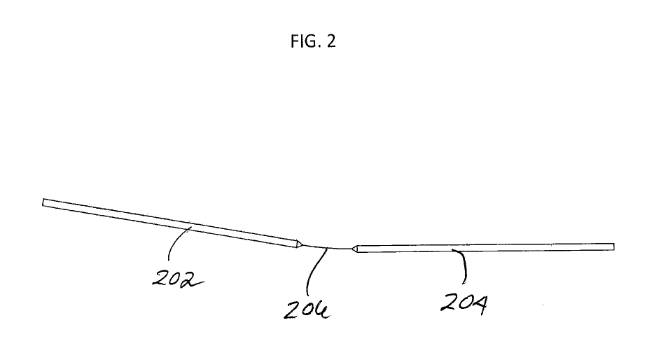

Because US steel pipe is usually sold in 21-ft sticks, one would usually weld a 5-ft long “plate section” between each stick of conventional pipe. FIG. 2 shows 21′-long sticks 202, 204, of 6″ pipe with a 5-ft long flexible section 206 that are bent on a 150-ft radius:

Such sticks of pipe are not true sections of an arc—they are short straight sections with bends. If 21-ft long sticks of pipe are not a smooth enough curve then one could cut the pipes in half and install more flexible sections to make the curve smoother.

The optimal width of the plates will be similar to or the same as the optimal diameter of pipe used. In general, the plate cross-sectional area should be the same as the cross-sectional area of the pipe—this keeps the axial strength and ampacity constant. If the plate width is the same as the pipe diameter, then the plate thickness would be about ⅛ of the width. An illustrative range of the plate width is about 3-12 inches. An illustrative range of the plate thickness is about 1/16 of an inch to 1.5 inches.

A plate with the optimal geometry defined would have between 0.5% and 1.5% of the bending moment of inertia of the pipe.

### Slotted Pipe Section

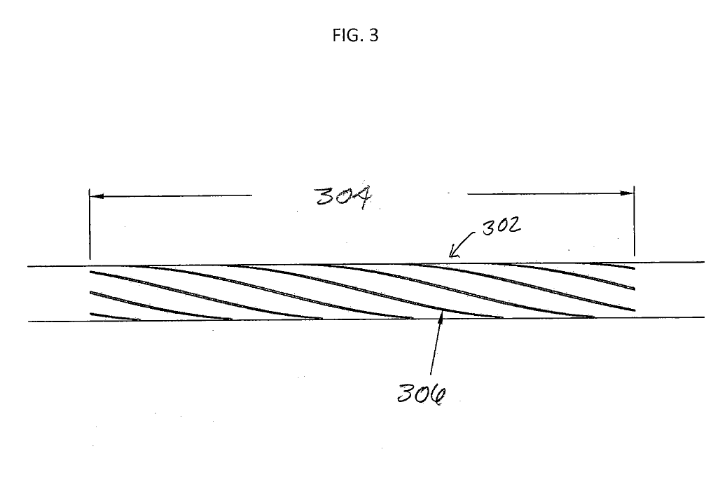

By slotting the pipe, the bending moment-of-inertia can be greatly reduced. An illustrative embodiment of a pipe 302 with a slotted section 304 is depicted in FIG. 3. Slots 306 are disposed in a spiral configuration, but can be slits or openings of other shapes and sizes, and in other patterns. For simplicity, the term “slot” is used generally.

In the illustrative embodiment of the invention, the pipe bands spiral 360° around the pipe. Because the pipe bands between the slots spiral 360° around the pipe, the bands are neither stretched nor compressed as the pipe bends. This reduces the resistance to bending for a spiral pattern. The spiral slotted pipe has a bending moment-of-inertia of about 0.2 in⁴—in other words, the spiral slotted section is over 100 times more flexible than an unslotted pipe. The spiral slotted pipe is less expensive to implement, has no welded transitions that can be subject to failure, and does not share the disadvantages of the other flexible segments described above.

In an illustrative embodiment of the invention, six slots are used and a slot length 12 times the pipe diameter. On a 6 in pipe they would be 72 in long. The width of the slots depends, at least in part, on the cutting method. An illustrative slot width is about 0.125 in. Slots would normally be cut with a plasma cutter, a laser, or steel cutting torch. Larger slot widths are possible such as 0.25 in and can be created for example, with a cutting torch. An illustrative range of slot width is about ⅛ in to about ¼ in.

The flexible-to-nonflexible ratio along the axial length of the electrode would generally be in the range of 1:3 to 1:6.

Although slots can be in a variety of configurations, they are preferably in a spiral to maximize the strength of the pipe as compared to other possible configurations such as longitudinal or partial circumferential slots. The spiral configuration also promotes pipe flexibility. In an illustrative example spiral slot section is in the range of about 6 to about 18 times the pipe diameter.

Slotting the pipe reduces the bending moment of inertia of the slotted section to between 0.5% and 1% of the unslotted pipe. If the slotted section makes up 25% of the total length of the pipe then the overall bending moment of inertia would be 2% to 4% of an unmodified pipe.

The slotted pipe embodiment of the invention has the advantage of being able to transport fluid. For example, oil or contamination can be extracted from the surrounding ground by use of a vacuum or reduced pressure applied to the slotted pipe. The number and size of slots can be modified according to the desired fluid transport, flexibility, and strength.

Slotted pipe that is used for the recovery of oil or the recovery of contamination is generally slotted such that the slot open area is about 1-5% of the total surface area of the pipe. If six ⅛″-wide slots are installed in a six-inch pipe as described above, then the slot open area would be 4% of the flexible interval, which is in the range of the desired open area for the recovery of fluids (at least for the flexible portion of the pipe). To make the pipe ideal for the recovery of fluids, one could either:
1. Increase the portion of the pipe length that has spiral grooves, or
2. Install conventional axial slots in most of the pipe and install spiral grooves in only a portion of the pipe as necessary to achieve the desired flexibility.

There are existing automated machines that can simultaneously cut multiple axial slots at low cost. These low cost slots can be used for most of the pipe length and the spiral slots can be used only as necessary to create the desired flexibility.

The geometry of the site and the drilling and pulling capacity of the drill rigs are factors to consider in selecting pipe size. Some rigs are optimized for small pipe (2″ HDPE is often used for fiber optic installations in neighborhoods). Some rigs are designed to drill run a 24″ pipe a mile under a river. For use contemplated in this invention, mid-size rigs would generally be used. The invention, however, is not limited to that size.

A general description of an ERH process to remove contamination or other material from soil and groundwater, in which the flexible electrodes can be used, follows.

Electrical Resistance Heating (ERH) can be used as a remediation technology to reduce the mass of volatile organic compounds (VOCs) in soil and groundwater. The technology is particular useful for clean up of chlorinated non-aqueous phase liquids (NAPLs)

Using electrodes inserted into the subsurface ERH heats the subsurface to at or near the boiling point of water by passing electrical current through contaminated soil and groundwater. The heating evaporates volatile contaminants in situ and steam strips them from the subsurface. Vapors and steam are then extracted, cooled, and treated using standard methods. The technology can remove, for example, volatile and semivolatile chlorinated and petroleum hydrocarbons from both vadose and saturated zones regardless of soil permeability or heterogeneity.

The subsurface can be heated to any temperature above ambient, but cannot exceed the boiling temperature of water at the pressure of the ERH depth. In most cases of environmental remediation, the subsurface is heated to near the boiling temperature of water, with a typical goal temperature range of 60° C. to 120° C. If the goal is to enhance the recovery of crude oil, then one often encounters reservoirs with pressures many times greater than atmospheric pressure and temperatures in the range of 150° C. to 300° C. are practical due to the high water boiling temperature at deep depths.

ERH can be applied using three or six phases of electricity. The electrodes can be functionally connected to a central processing unit (CPU) of a computer to control and adjust the phases of electricity to be applied in ERH. The electrodes are typically energized using 60 Hz alternating current. The electrical energy evaporates target materials and also produces steam as a carrier gas to sweep the vapors to recovery wells for capture and eventual treatment at the surface.

ERH can be used to steam strip volatile organic compounds (VOCs) from the subsurface, enhance vapor and multi-phase extraction systems, and increase biological degradation and chemical dechlorination reaction rates.

Deploying ERH requires a power control unit (PCU) to condition and control the application of power and electrodes to deliver power to the subsurface. For remediation purposes, recovery wells to collect steam and contaminant vapors, a steam condenser, a vapor treatment system, and control and data acquisition systems are also used. Recovery wells, treatment systems and control and data acquisition systems are also used for an ERH oil recovery system.

Electrodes are placed in the subsurface throughout the treatment area using standard drilling or pile driving techniques. The spacing between the electrodes is usually 14 to 22 feet. The depth at which electrodes may be placed at a given site is only dependant upon the depth to which drilling can be accomplished.

The PCU directs three-phase electricity from municipal power lines to the electrodes. The electricity may be directed to groups of electrodes, or electrode depth intervals, either simultaneously or sequentially depending on the size of the volume being treated, or the desired heating pattern.

Various embodiments of the invention have been described, each having a different combination of elements. The invention is not limited to the specific embodiments disclosed, and may include different combinations of the elements disclosed.

While the invention has been described by illustrative embodiments, additional advantages and modifications will occur to those skilled in the art. Therefore, the invention in its broader aspects is not limited to specific details shown and described herein. Modifications, for example to the configuration of the flexible portions of the electrodes may be made without departing from the spirit and scope of the invention. Accordingly, it is intended that the invention not be limited to the specific illustrative embodiments, but be interpreted within the full spirit and scope of the appended claims and their equivalents.

1. A flexible electrode comprising:
one or more flexible conductive portions; and
one or more substantially rigid conductive portions;
wherein the flexible electrode is configured for use in electric resistance heating (ERH) applications.

2. The flexible electrode of claim 1 wherein the rigid portions have a diameter in the range of about 3 inches to about 12 inches.

3. The flexible electrode of claim 1 wherein:
the one or more flexible portions are flat plates; and
the one or more rigid portions are pipe.

4. The flexible electrode of claim 1 wherein the flexible-to-rigid length ratio is in the range of about 1:3 to about 1:6.

5. The flexible electrode of claim 1 wherein the flexible section is in the range of about 10-14 times the pipe diameter.

6. The flexible electrode of claim 1 wherein the electrode is made flexible by reducing its moment of inertia in the bending plane in at least a portion of the electrode.

7. The flexible electrode of claim 1 wherein the flexible portions are rods.

8. The flexible electrode of claim 7 wherein rod diameter is in the range of one-third to one-half of the pipe diameter.

9. The method of claim of claim 7 wherein each rod section is in the range of about 5 to 10 pipe diameters long.

10. The flexible electrode of claim 1 wherein the electrode comprises:
a conductive pipe having one or more sections with slots therein.

11. The flexible electrode of claim 10 wherein the length of the one or more slotted pipe sections is each between 6 to 18 times the pipe diameter.

12. The flexible electrode of claim 10 wherein the slot width is in the range of about ⅛ inch to about ¼ inch.

13. The flexible electrode of claim 10 wherein slots are in a spiral configuration.

14. A method of electric resistance heating (ERH) comprising:
forming an electrode with:
one or more flexible conductive portions; and
one or more substantially rigid conductive portions;
inserting the flexible electrode into the subsurface;
energizing the electrode to heat material in the subsurface.

15. The method of claim of claim 14 further comprising:
selecting the length of the flexible electrode portion to enable the electrode to be inserted non-perpendicularly in the subsurface and under a structure with a smaller offset than necessary with a rigid electrode.

16. The method of claim of claim 15 wherein the offset radius of the flexible electrode is in the range of about 150 feet to about 500 feet.

17. The method of claim 15 wherein at least a portion of the electrode is inserted in a position in the range of 0 to 45° to the horizontal.

18. The method of claim of claim 14 comprising heating the subsurface to a temperature in the range of about 150° C. to 300° C.

19. The method of claim of claim 14 comprising heating the subsurface to a temperature in the range of about 60° C. to about 120° C.

20. The method of claim 14 wherein the electrode comprises:
one or more pipe portions; and
one or more flat plate portions.

21. The method of claim 14 wherein the electrode comprises:
a pipe having one or more section having slots therein.

22. The method of claim 21 further comprising:
extracting fluid from the subsurface into the slotted section of the electrode and transporting it through the electrode.

23. The method of claim of claim 22 further comprising applying a vacuum to the electrode to extract the fluid.

24. The method of claim of claim 22 comprising:
selecting the number and size of slots according to the desired fluid transport.

25. The method of claim 14 further comprising:
reducing the mass of volatile organic compounds in the subsurface by extracting them in a vapor form through the pipe.

26. The method of claim 14 further comprising:
extracting crude oil from the subsurface.

27. An ERH system comprising:
one or more flexible electrodes functionally connected to a CPU unit.

28. A method of fabricating a flexible electrode comprising:
providing a reduced moment of inertia in the bending plane in at least a portion of the electrode.

29. The method of claim 28 wherein the electrode is a pipe and the moment of inertia is reduced by providing one or more slots in at least a portion of the pipe.

30. The method of claim 10 wherein the electrode comprises sections of pipe and wherein the moment of inertia in the bending plane is reduced by providing one or more segments of conductive plate interspersed between the segments of pipe.
